(19) United States
(12) Patent Application Publication
(10) Pub. No.: US 2014/0257862 A1
(43) Pub. Date: Sep. 11, 2014

(54) MOBILE APPLICATION FOR RISK MANAGEMENT

(71) Applicant: Wildfire Defense Systems, Inc., Red Lodge, MT (US)

(72) Inventors: Bradly Jay Billman, San Antonio, TX (US); Wayne Hartman, San Antonio, TX (US); Charles L. Oakes, III, Boerne, TX (US); Elizabeth Rubin, San Antonio, TX (US); Mark Zuwala, San Antonio, TX (US); Emily Gray, San Antonio, TX (US); Sandra Sausman, San Antonio, TX (US)

(73) Assignee: Wildfire Defense Systems, Inc., Red Lodge, MT (US)

(21) Appl. No.: 13/678,301

(22) Filed: Nov. 15, 2012

Related U.S. Application Data
(60) Provisional application No. 61/564,664, filed on Nov. 29, 2011.

(51) Int. Cl. G06Q 40/08; G06Q 50/16

(52) U.S. Cl. CPC G06Q 40/08; G06Q 50/16
USPC 705/4

(57) ABSTRACT

A system and method provide determining a risk of a natural hazard associated with a piece of real property and identifying mitigatable items located around the property by collecting local data using at least one sensor. The local data includes information related to risk factors associated with the property. In an embodiment, the local data is collected using a mobile computing device that includes at least one sensor and a mobile application. External data may be also combined with the local data for further analysis to identify mitigatable items. After identifying mitigatable items around the property, the mitigatable items can be modified or removed to reduce the risk of a natural hazard associated with the property. The systems and methods further include computing, using a data processor, an insurance premium of an insurance policy using a computed risk level of a natural hazard associated with the property.

### CROSS-REFERENCES TO RELATED APPLICATIONS

This application claims priority to U.S. Provisional Patent Application No. 61/564,664, filed Nov. 29, 2011, entitled “Mobile Application for Risk Assessment,” the disclosure of which is hereby incorporated by reference in its entirety for all purposes.

### BACKGROUND OF THE INVENTION

Customers demand more of the products and services they use than ever before. They insist that the companies they deal with on a regular basis provide them greater and greater levels of accuracy and more tailored service offerings. Companies configure and operate ever increasing numbers of computer systems to achieve this. Using sources of information that have traditionally been unavailable is now expected.

### SUMMARY OF THE INVENTION

The present invention relates generally to risk assessment systems. More specifically, the present invention relates to methods and systems for collecting local data related to a vicinity of a real property using at least one sensor to determine a risk of a natural hazard associated with the property. Merely by way of example, the invention has been applied to a method of assessing susceptibility of real property to a natural hazard, such as a wildfire or a flood, using a mobile computing device and a mobile application by collecting and analyzing local data. Mitigation procedures are also provided to property owners to reduce a potential damage caused by a natural hazard. The invention has been also applied to an underwriting process for property insurance policies and to customize the price of an insurance premium according to computed risk levels. The methods and techniques can be applied to a variety of risk assessment systems.

According to an embodiment of the present invention, a method of determining mitigatable items on or around a real property is provided to reduce a risk of a natural hazard, in particular a wildfire. The method is performed by a data processor of a mobile computing device. The method includes providing a data processor, a memory, and at least one sensor, wherein the memory and the at least one sensor are operatively coupled to the data processor. The method also includes receiving a request at the mobile computing device to collect local data related to a predetermined vicinity of a piece of real property using the at least one sensor, wherein the local data includes information related to mitigatable items that can be mitigated to reduce a wildfire risk associated with the property. The method further includes collecting the local data using the at least one sensor, determining, using the data processor, one or more of the mitigatable items, and displaying information related to the one or more mitigatable items.

According to another embodiment of the present invention, a method determines a risk of a natural hazard, such as a wildfire, associated with real property. The method includes providing a data processor, receiving local data related to a predetermined vicinity of the property, wherein the local data includes information related to one or more mitigatable items that can be mitigated to reduce a wildfire risk associated with the real property. The method also includes computing, using the data processor, a risk level of the wildfire associated with the property using the local data and providing, to a user, the risk level of the wildfire associated with the property. In an implementation, internal proprietary data and/or external data, such as environmental data, may be included in the analysis. In another implementation, the method can be performed by a mobile computing device. In yet another implementation, the method can be performed by an insurance management system or by other systems in a server.

According to another embodiment of the present invention, a method provides an insurance policy for real property. The method includes providing a data processor, and receiving local data related to a predetermined vicinity of the property, which is collected by at least one sensor. The local data includes information related to risk factors including one or more mitigatable items that contribute to a risk of a natural hazard, such as a wildfire. The method also includes computing, using the data processor, a risk level of the wildfire risk associated with the property using the local data and determining, using the data processor, whether the risk level is less than a threshold. The method further includes issuing an insurance policy for the property with an insurance premium if the risk level is less than the threshold. If the risk level is above the threshold, a notification is transmitted to a user that the property is uninsurable.

According to another embodiment of the present invention, a method provides adjusting an insurance premium of an insurance policy according to mitigation efforts by homeowners. The method includes providing a data processor and receiving local data related to a predetermined vicinity of a piece of real property from one or more sensors. The local data includes information related to risk factors including one or more mitigatable items that contribute to a risk of a natural hazard. The method also includes identifying one or more mitigatable items from the local data and transmitting, to a user, the one or more mitigatable items. The method further includes receiving, from the user, mitigation information related to removal or modification of the one or more mitigatable items. A new risk level is computed using the mitigation information, and an insurance premium of an insurance policy is adjusted using the new risk level.

According to another embodiment of the present invention, an insurance management system is provided. The insurance management system includes a data processor, engines, a memory, and a communications module all operatively coupled to the data processor. The communication module and the engines are operably coupled together to perform any of the steps of methods described in the present application.

According to another embodiment of the present invention, a mobile computing device is provided. The mobile computing device includes a data processor, a memory, and a communications module all operatively coupled to the data processor. The mobile computing device also includes a mobile application which is stored in the memory. The mobile application includes a plurality of instructions, which, when executed using the data processor, provides determining a risk of a natural hazard associated with a piece of real property and identifying mitigatable items around the property.

According to another embodiment of the present invention, a non-transitory computer-readable storage medium including a plurality of computer-readable instructions tangibly embodied on the computer-readable storage medium is provided. The plurality of computer-readable instructions, which, when executed by a data processor, provides determining a risk of a natural hazard associated with real property and identifying mitigatable items around the property. The plurality of instructions includes instructions that cause the data processor to perform any of the steps of method described in the present application. In an embodiment, the plurality of instructions are configured to be downloaded to a mobile computing device.

Numerous benefits are achieved by way of the present invention over conventional techniques. For example, embodiments of the present invention provide methods and systems that allow a homeowner to identify risk factors in real-time and self-mitigate risks of natural hazards associated with the homeowner's property by using a mobile computing device. Using a self-guided service provided by technologies according to embodiments of the present invention, a homeowner can identify items, objects, or features around the property that can be addressed and mitigated to minimize potential hazardous conditions surrounding the property. Since homeowners can use a self-guided computer-aided service rather than requiring professional wildfire fighters or other experts to inspect the properties, there are benefits of cost savings for homeowners and insurance companies.

Additionally, embodiments of the present invention enable the insurance companies to tailor insurance premiums according to a computed risk level of a natural hazard risk associated with a piece of real property. Such premiums can be adjusted in response to homeowners' efforts to reduce risk levels of natural hazards associated with their homes. Therefore, homeowners can be active participants in determining insurability of their homes and insurance premiums. These and other embodiments of the invention along with many of its advantages and features are described in more detail in conjunction with the text below and attached figures.

### BRIEF DESCRIPTION OF THE DRAWINGS

FIG. 1 is a high level block diagram illustrating an apparatus for computing a risk of a natural hazard associated with real property and for issuing an insurance policy according to an embodiment of the present invention;

FIG. 2 is a high level schematic diagram illustrating an interaction of an insurance management system with a user and sensors according to an embodiment of the present invention;

FIG. 3A is a high level flowchart illustrating a method of determining mitigatable items that contribute to a natural hazard risk associated with real property according to an embodiment of the present invention;

FIGS. 3B and 3C illustrate a wildfire hazard assessment checklist according to an embodiment of the present invention;

FIG. 4 is a high level flowchart illustrating a method of issuing an insurance policy according to an embodiment of the present invention;

FIG. 5 is a high level flowchart illustrating a method of issuing an insurance policy according to an embodiment of the present invention;

FIG. 6 is a high level schematic diagram illustrating a computer system including instructions to perform any one or more of the methodologies described herein;

FIG. 7A is a high level schematic diagram illustrating a graphical user interface for surveying real property according to an embodiment of the present invention;

FIG. 7B is a high level schematic diagram illustrating a graphical user interface for surveying real property according to an embodiment of the present invention;

FIG. 7C is a high level schematic diagram illustrating a graphical user interface displaying an augmented view of an image of a yard according to an embodiment of the present invention; and

FIG. 7D is a high level schematic diagram illustrating a graphical user interface for displaying an aerial map of real property and its surrounding according to an embodiment of the present invention.

### DETAILED DESCRIPTION OF SPECIFIC EMBODIMENTS

Embodiments of the present invention relate to technologies to facilitate homeowners and/or renters in finding, acquiring, insuring, and/or maintaining real property. Technologies related to embodiments of the present invention support a homeowner/renter, for example, a member of the present assignee, with the initial preparation associated with the purchase of a home and/or rental of a home/apartment. Such initial preparation can include advice and counseling related to a person's ability to afford a home or apartment, development of a financial plan to facilitate the acquisition, web-enabled self-service systems (e.g., home purchase calculators) used to determine financial goals and requirements, and/or on-line member communities related to homeownership and/or rental.

After a person completes initial preparation, technologies related to embodiments of the present invention assist the person in finding suitable properties through the use of rent/buy listings including information tailored to each person's interests and background. For example, pre-approval of the person for mortgage rates and/or homeowner's/renter's insurance can be used to provide rich information content as part of the search process. On-line member communities can be used to assist users in finding property that is suitable for the particular user's interests and income.

Additionally, technologies related to embodiments of the present invention provide for assistance in the purchase/rental transaction, including obtaining a mortgage and provision of assistance in negotiating the purchase or lease. Protection of the newly acquired home or rented property is also related to embodiments of the present invention, in one of several forms including homeowner's insurance, mortgage life insurance, renter's insurance, flood insurance, personal property insurance, home security systems, home warranties, and the like.

Moreover, technologies related to embodiments of the present invention provide a person with assistance in moving to, maintaining and/or renovating, and/or refinancing the newly purchased or rented property. Thus, embodiments of the present invention relate to technologies that provide a one-stop home resource for delivering home solutions related to buying, selling, renting, and/or owning real property. In particular embodiments, members of a membership organization (e.g., the present assignee) utilize the methods and systems described herein to manage their real property interests and interact with other community members to enable new concepts related to homes and other real property.

Homes can be subject to many natural hazards, such as wildfires, floods, hailstorms, mudslides, or the like. Although natural hazards cannot be prevented, there are some preventive measures that homeowners can undertake to mitigate the risk of such natural hazards. For example, providing a defensible space zone around a home can protect it from an approaching wildfire. While homeowners can prevent or reduce a potential loss due to wildfires, they are often not aware of conditions around their homes that can increase the risk of wildfires. Insurance companies lack resources to inspect all homes prone to wildfires or other natural hazards. A lack of inspection by insurance companies and a lack of proper mitigation efforts by homeowners can be devastating for homeowners and can result in large losses for insurance companies.

Technologies according to the present invention allow a user to capture local data related to a risk of a wild fire or other natural hazards associated with the user's property in real-time. Using a mobile computing device and sensors, a user can obtain videos, photos, images with enhanced data, and/or other sensor measurements from the vicinity of the property. The collected local data can be transmitted to an insurance management system, in real-time, to determine a risk level of a natural hazard associated with the property. Additionally, a mobile computing device can include a mobile application (e.g., an application program for mobile platforms) that can be used by a homeowner to identify mitigatable items that can be removed or modified to reduce a natural hazard risk associated with the property. Thus, in embodiments of the present invention, the mobile computing device can empower homeowners to self-mitigate against natural hazards.

In an embodiment of the present invention, a mobile application that provides an augmented view can be used to guide a user, in real-time, in identifying and mitigating items around the user's property to reduce a risk of home loss due to wildfires or other natural hazards. A mobile application on a mobile computing device can provide an augmented view of an area around the property with view-finder type indicators to show a distance between objects and areas to focus on. In some embodiments, the mobile application can be used in conjunction with plant identifying applications, object recognition software, and/or external database of information. For example, the view-finder (camera/video) feature of the application can use object recognition technology to automatically identify risks in real-time and highlight areas with risk factors on the screen. The mobile application can further provide a summary at the end of an inspection with a recommendation list for a user, other technologies, and solutions to reduce the risk of natural hazards associated with a home. The technologies in accordance with embodiments of the present invention can provide a new approach to self-mitigation for homeowners to reduce the risk of natural hazards.

For wildfires, one of the important steps in reducing the wildfire risk is proper removal of fuel around a home to create a defensible space or barrier between the home and plants or other objects that act as fire fuel. It is difficult for a homeowner to identify objects that are potential fire fuel sources or to determine a distance for clearance between objects. In an embodiment of the present invention, a mobile computing device having a camera can be provided with a mobile application. The mobile application can provide an augmented view or augmented reality that can show a proper distance from the home to plants and objects that need to be removed to create a defensible space around a home. Thus, a mobile application in accordance with an embodiment of the present invention can provide automatic distance measurements.

Embodiments of the present invention can be practiced with a sensor other than a camera. For example, a mobile computing device can include a GPS receiver or other types of location detectors as a sensor, in addition or in alternative to the camera. The GPS receiver can provide GPS coordinates for a boundary around the property that a user needs to clear potential fuel sources or GPS coordinates of plants or objects that need to be removed. In some embodiments, a mobile application can include a function where a user can view images of augmented reality of how the user's property would appear after removing plants and objects that act as fire fuel. Such augmented images can provide the user with information related to safeguarding the user's property against wildfires or other natural hazards.

Embodiments of the present invention can be used by a number of different individuals and entities. For example, a homeowner can use embodiments of the present invention to self-mitigate against natural hazards. Home buyers, realtors, home builders, investors, and the like can also use a mobile application in accordance with embodiments of the present invention to determine the amount of work and cost required to address risk factors associated with a home during the home purchase process. The mobile application can be also purchased and utilized by contractors, whom, in turn, can provide services to homeowners who would rather hire contractors for mitigation work. Furthermore, insurance companies can use embodiments of the present invention to provide mitigation recommendations to homeowners. Insurance premiums of insurance policies can also be adjusted in response to homeowners' mitigation efforts to reduce risk levels of natural hazards associated with their homes.

As described more fully throughout the present specification, embodiments of the present invention provide systems and methods for determining items that can be mitigated to reduce a risk of a natural hazard associated with a piece of real property and for determining insurability and an insurance premium for the property. Additional description related to these embodiments is provided throughout the present specification and more particularly below. The figures described in this application are used to illustrate embodiments of the present invention, and are not in any way intended to be restrictive of the broad invention. Embodiments of the present invention are not limited to the specific arrangements and constructions shown and described. For example, features shown in one figure can be combined with features shown in other figures, and embodiments described in one section can be combined with embodiments described in other sections of the present application.

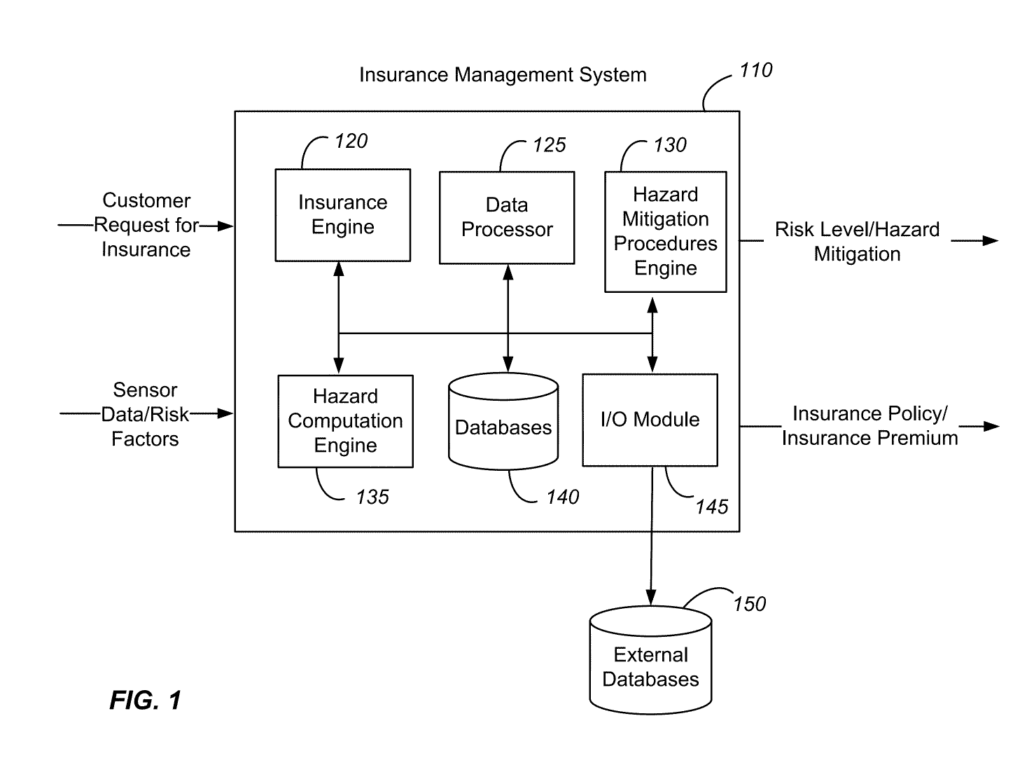

FIG. 1—Insurance Management System

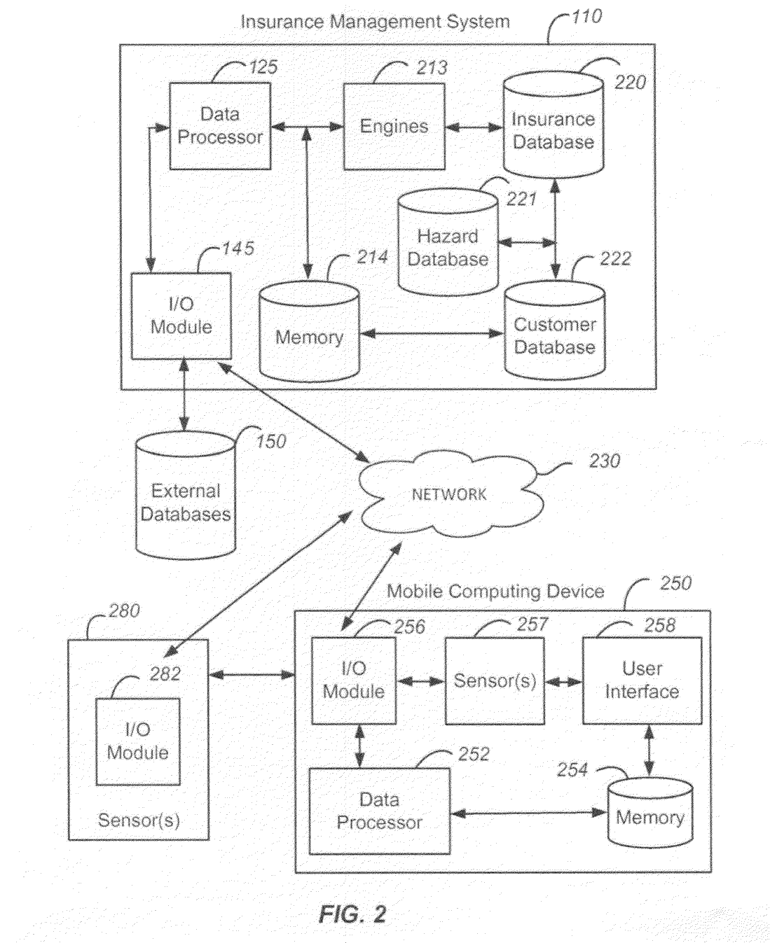

FIG. 1 is a high level block diagram illustrating an apparatus 110, referred to as an insurance management system, for processing sensor data or other risk factors to determine a risk of a natural hazard associated with a piece of real property and an insurance premium of an insurance policy for the property in accordance with an example embodiment. As illustrated in FIG. 1, sensor data or other risk factors associated with a piece of real property to be insured is transmitted to an insurance company operating the apparatus illustrated in FIG. 1. Sensor data can be obtained from one or more sensors described in the present application. The apparatus also receives a request from a customer for an insurance policy. The insurance management system 110 includes an input/output (I/O) module 145 that can receive data as well as send data back to external databases 150, which may be operated by an entity operating the insurance management system 110 or by a third party. Although not shown in FIG. 1, the input/output module 145 also interacts with a mobile computing device and sensors shown in FIG. 2 to receive sensor data, which are stored in databases 140, and to send back data to the mobile computing device.

Utilizing the illustrated inputs, a data processor 125 and a hazard computation engine 135 interact with the databases 140 to facilitate computation of a risk level of a natural hazard associated with the property based on received sensor data. Additional information from the external databases 150 and the internal databases 140 can also be used, in conjunction with the sensor data, in the computation of the risk level. The data processor 125 and an insurance engine 120 also interact with the databases 140 to determine insurability and an insurance premium associated with the property. Additionally, the data processor 125 and a hazard mitigation procedures engine 130 interact with the databases 140 to determine mitigatable items and mitigation procedures for the property to reduce the risk of natural hazards associated with the property. After analyzing the inputs, the insurance management system 110 may provide, to a user, various outputs including a risk level of a natural hazard associated with the user's property, hazard mitigation procedures to reduce the risk level, an insurance policy, and an insurance premium for the property.

While the insurance management system 110 can also include other databases, engines, systems, subsystems, or the like, some of these components are not illustrated in FIG. 1. FIG. 1 illustrates only the components that process sensor data and a request for insurance policies. Also, although external databases 150 are illustrated in FIG. 1, they are not required by embodiments of the present invention. In some embodiments, sufficient information related to sensor data processing, mitigation procedures, and insurance issuance are maintained internally within the insurance management system 110. In some embodiments, data from both internal and the external sources is integrated to provide the system operator with data that is both useful and low in cost, however, this is not required by the present invention.

FIG. 2—Interaction of Insurance Management System and User Mobile Computing Device

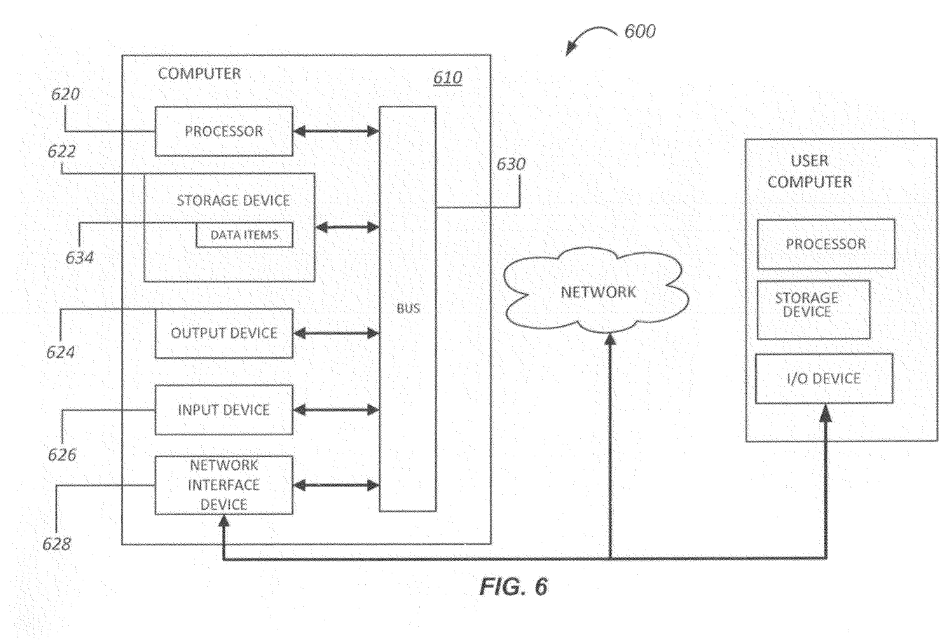

FIG. 2 is a high level schematic diagram illustrating an interaction of an insurance management system 210 with a user according to an embodiment of the present invention. As illustrated in FIG. 2, a user operating a mobile computing device 250 interacts with the insurance management system 210 through network 230. The mobile computing device 250 can include a handheld mobile phone (e.g., iPhone™ or Android™ smart phones), a handheld mobile device (e.g., iPod Touch™), a tablet (e.g., iPad™), a PDA, a notebook computer, or the like. While an embodiment shown in FIG. 2 illustrates the use of a mobile computing device, any user computers including a desktop computer may be used to interact with the insurance management system. The insurance management system 210 includes a data processor 212, also referred to as a processor, and a memory 214. The description provided in relation to processors and memory in FIG. 6 is also applicable to the data processor 212 and memory 214. An input/output module 216 (also referred to as a communications module) is provided to enable communication between the insurance management system and external users, mobile computing devices, computers, sensors, or the like.

The insurance management system 210 also includes an insurance database 220, a hazard database 221, a customer database 222, and external databases 224, which can be operated on behalf of an insurance services provider and utilized in conjunction with other system elements. The insurance database 220 stores information related to insurance policies held by a customer and an insurance claim history of the customer. The hazard database 221 stores information related to hazardous conditions associated with specific properties or broader areas (e.g., city, county, zip code level, or the like). The customer database 222 stores data on customers/members of an organization, which may include both existing customers and/or potential customers of an insurance company. The user of the term “member” is not intended to limit the scope of the present invention but merely to provide an example of a customer who may be benefited by embodiments of the present invention. In this sense, the use of the term member is intended to cover the term customer. The data on the member/customer may include a member's name, address, date of birth, Social Security number, credit history, and other demographic information, information regarding insurance policies held by the member, information regarding the member's financial accounts held by the member, or the like.

The insurance management system 210 is communicatively coupled, in one example, to external databases 224, which may include additional information related to a risk of a natural hazard associated with different areas. The insurance database 220, in contrast with the external databases 224, is maintained by the company operating the insurance management system 210, typically an insurance company such as the present assignee. As described more fully throughout the present specification, the I/O module 216, the data processor 212, memory 214, insurance database 220, hazard database 221, and customer database 222 are utilized to receive inputs from a user operating the mobile computing device 250, Utilizing the received inputs, engines 213 (which can include various engines shown in FIG. 1) compute and determine a risk level of a natural hazard associated with the user's property, mitigation procedures, approval or denial of an insurance policy, and an insurance premium.

A user operating the mobile computing device 250 interacts with the insurance management system 210 through network 230, which may be the Internet. In some embodiments, the network 230 is partly or wholly a private wide area network, local area network, or the like. In an embodiment described in additional detail below, the mobile computing device 250 can include at least one sensor 257 to collect sensor data from the vicinity of the user's property. In some embodiments, the sensor data can be transmitted to the insurance management system 210 using user interface 258, which results in data transfer through I/O module 256 and network 230. The sensor data from the user can be used by the insurance management system 210 to determine whether a risk level associated the user's property is below a threshold for issuance of an insurance policy and to compute an insurance premium for the policy.

The mobile computing device 250 can receive responses such as requests for additional information from the insurance management system 210, process the received information using data processor 252, store the received and/or processed information using memory 254, and display the processed/stored information using the user interface 258. As an example, a customer of an insurance company (e.g., a member of the present assignee) can use the mobile computing device 250 to interact with the insurance company (e.g., the present assignee) through the Internet, providing and receiving information through web pages operated by the insurance company (e.g., the present assignee's website). A website hosted by the insurance management system or other systems in a server can run a software or application, which allows for instance, analysis of a risk of a natural hazard associated with a piece of real property.

In another example, a customer can download a mobile application stored in the memory 214 of the insurance management system 210 or in other systems on a server to the user's mobile computing device 250 through the Internet. Through the mobile application installed on the mobile computing device, a user can collect sensor data and interface with the insurance management system 210 or other systems in a server. In yet another example, some of the features in accordance with embodiments of the present invention may be provided by the website and others by a downloaded mobile application.

Upon opening the mobile application and/or accessing the website for the first time, a user may be asked to log in or create a new account. Embodiments of the present invention may allow the user to enter the application without signing or registering; however, accessible features may be limited for an unregistered user. Typically, a user that already has an account and previously activated the account on an existing mobile device may be recognized so that the user is not required to log into the system each time the user launches the application or access the website.

In an embodiment illustrated in FIG. 2, the mobile computing device 250 has one or more sensors 257 in the user computing device 250 that can collect local data from the vicinity of the user's property. Any suitable sensor may be included in the mobile computing device 250. As an example, the mobile computing device 254 may include a camera and/or a GPS receiver as sensors 257 to collect sensor data such as videos, photos, other images from the property, and locations of hazardous items around the property. Other types of sensors can also be included or operatively coupled to the mobile computing device. Sensor data collected by the mobile computing device 250 can be analyzed to determine mitigatable items around the property that can be removed or modified to reduce the risk of natural hazards associated with the property.

In another embodiment, one or more sensors 280 may be deployed around the property to gather additional local data related to the vicinity of the user's property. For example, one or more sensors may be installed around the perimeter of the user's property at certain locations to continuously monitor the locations. The sensors can include, but are not limited to: soil sample sensors, thermometers, humidity sensors, wind sensors, cameras located on the property, thermal sensors, infrared and radiation sensors, lidar, animal activity and migration sensors, mobile biological sensors, vegetation and fuel loads monitors, odor sensors, chemosensors, DNA analyzers, and the like. These sensors can detect odors, dryness, temperature, moisture level in the air, or the like in the vicinity of the property. In some embodiments, the plurality of sensors can form a mesh network of sensors that can provide information related to environmental factors associated with the property.

The sensors 280 can communicate with both the insurance management system 210 and the user mobile computing device 250 via a network 230 using an input/output module 282. The insurance management system 210 and the mobile computing device 250, in turn, can analyze sensor measurements from the sensors 280 to determine a risk of a natural hazard associated with the property and to identify mitigatable items located in the vicinity of the property. The sensors can provide sensor measurements periodically, continuously, or upon a request by the user or by an insurance company operating the insurance management system 210. Additional detail related to sensors deployed around a home is described in a copending U.S. patent application Ser. No. 12/769,563, filed Apr. 28, 2010, which is hereby incorporated by reference in its entirety.

Although additional sensors 280 are illustrated in FIG. 2, this is not required by embodiments of the present invention. In some embodiments, one or more sensors included in the mobile computing device 250 are sufficient to obtain local data necessary for determining a risk of a natural hazard associated with a piece of real property and to identify mitigatable items from the property.

In embodiments of the present invention, local data obtained from one or more sensors described herein can be stored in a number of different databases. For example, the local data may be stored in the memory 254 of the mobile computing device 250. In another example, the local data may be transmitted to the insurance management system 210 and stored in the hazard database 221 and/or customer database 222. In some embodiments, the local data may be transmitted externally and stored in an external network, server, or device, such as external databases 224 or a cloud based or account based storage.

In addition, external data related to a risk of a natural hazard associated with a piece of real property can be obtained from other sources. The external data refers to data which is not local data captured by sensors in accordance with an embodiment of the present invention. As an example, the external data related to a risk of a natural hazard associated with the property can include data layers from geographical information system (GIS), which can contain all types of geographically referenced data at a macro level. Examples of external data may also include environmental conditions such as drought conditions, lightning conditions, storm surge risk data, historical fire data, or the like that may increase fire risks for the property or for a greater area in which the property is located. The external data may be accessed from external databases 224 or from a cloud based or account based storage. In some embodiments, the external data associated with properties of customers may be stored in the hazard database 221 and/or customer database 222 of the insurance management system. The external data associated with a particular piece or real property (or a greater area in which the property is located) may be also stored in the memory 254 of the mobile computing device 250.

The local data, the external data, or both may be analyzed to determine a risk of a natural hazard associated with real property or mitigatable items around the property. Analysis of the data (e.g., local data, external data, or both) may be performed by a data processor of the mobile computing device 250. Alternatively or additionally, the data including sensor measurements may be transmitted to the insurance management system 210, which, in turn, performs the analysis to determine a risk level of a natural hazard associated with real property and mitigation procedures using one or more engine 213. In some embodiments, analysis can be performed in cloud computing using a remote server. Cloud computing can be performed using a mobile computing device, a personal computer, or the like to access a server running the software or application in accordance with embodiments of the present invention.

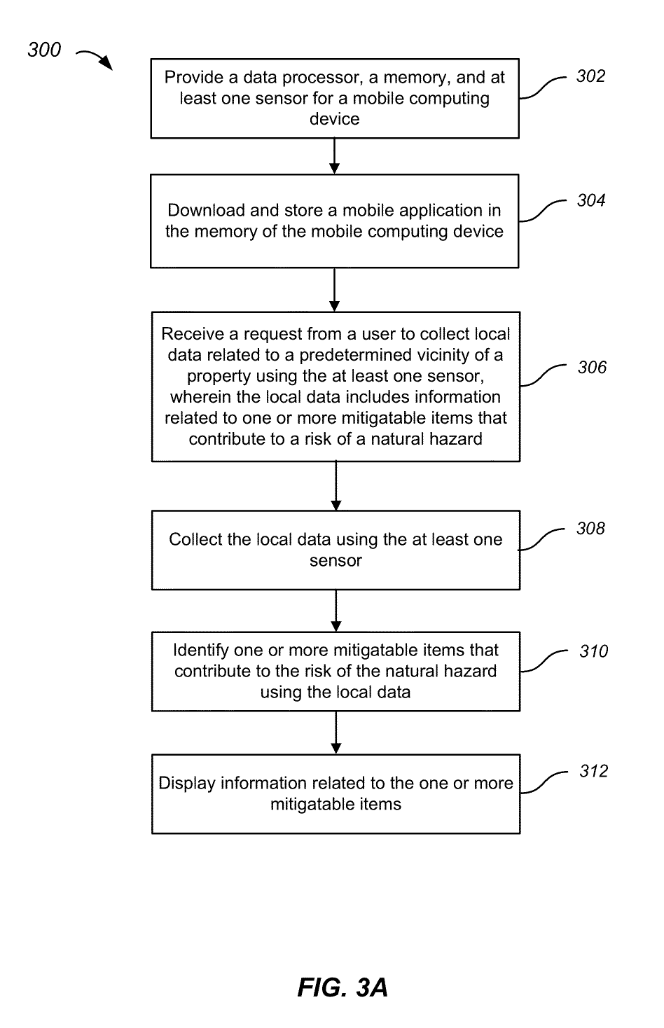

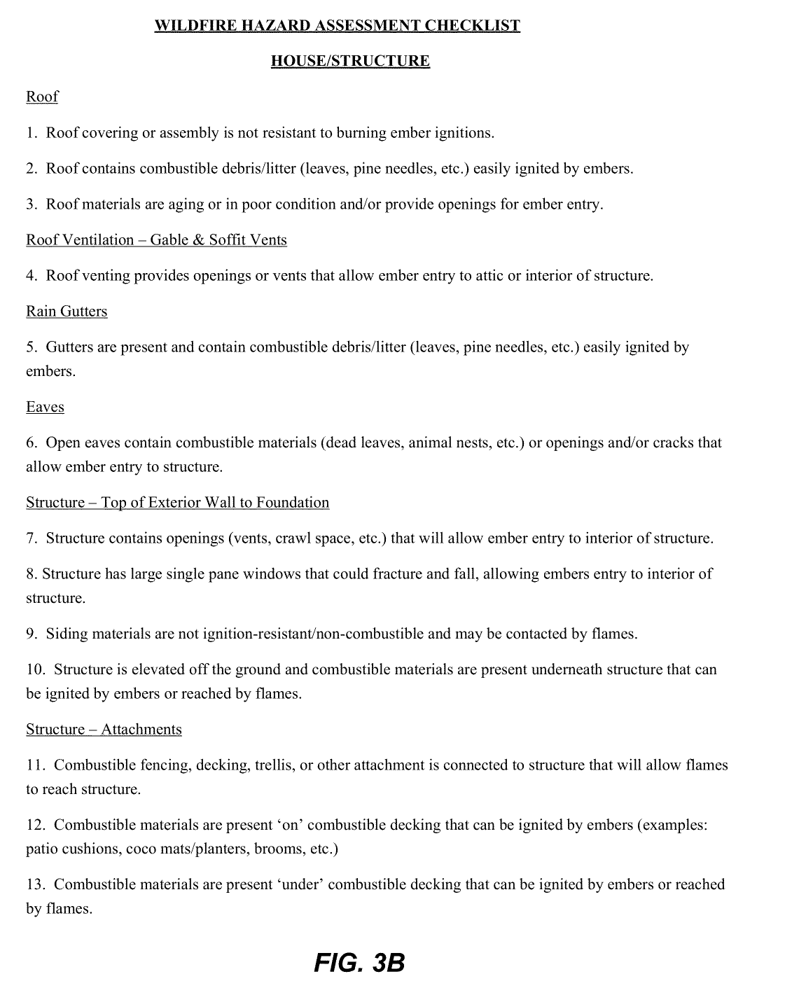

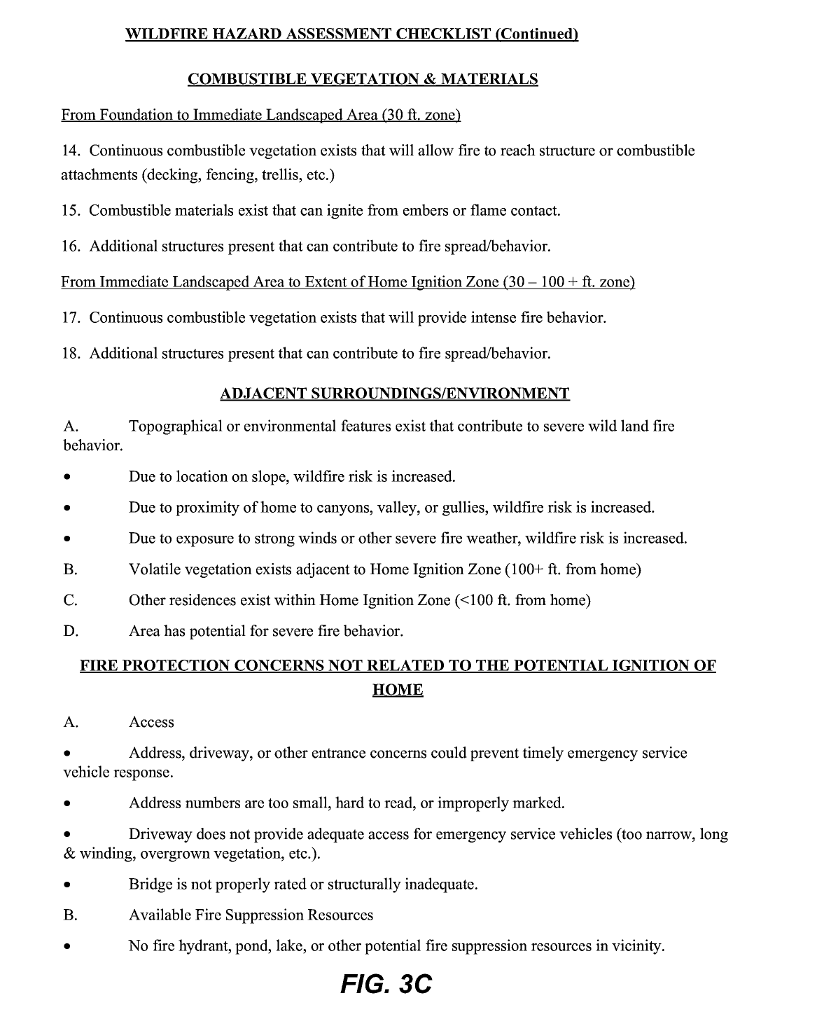

FIG. 3A—Assessment of Mitigatable Items Using Sensors and Mobile Computing Device

FIG. 3A is a high level flowchart illustrating a method performed by a mobile computing device according to an embodiment of the present invention. In an embodiment illustrated in FIG. 3A, the method 300 can be used to identify mitigatable items around a piece of real property that contribute to a risk of a natural hazard associated with the property. As used herein, real property or property can include residential property or commercial property, such as a home, a house, an apartment, a condominium, a commercial building, or the like. Embodiments of the present invention can provide a property owner with an opportunity to minimize potential damages by addressing identified mitigatable items prior to a natural hazard.

In FIG. 3A, the method 300 includes providing a data processor, a memory, and at least one sensor for a mobile computing device (302). The memory and at least one sensor are operatively coupled to the data processor of the mobile computing device. As described in relation to FIG. 2, one or more sensors can collect local data useful in determining risk factors of a natural hazard associated with real property. As an example, the mobile computing device may include a camera as a sensor which can collect videos, photos, or other images from the vicinity of the property in real-time. In another example, the mobile computing device may include a GPS receiver to receive a GPS signal. The GPS receiver can assist a user in determining a boundary of a defensible space zone for the property and to mark positions of identified mitigatable items in the defensible space zone. In some embodiments, the mobile computing device may include one or more additional sensors, or may be communicatively coupled to additional sensors deployed around the property.

The method can also include downloading or installing, on a mobile computing device, one or more mobile applications for surveying real property from, for example, an insurance management system (304). A mobile application can be stored in a memory of the mobile computing device and operate via a data processor of the mobile computing device. Through a mobile application on a mobile computing device, a user can collect local data using sensors operatively coupled to the mobile computing device. Through a mobile application, a user can also be provided with enhanced reality of images from the vicinity of the property. A mobile application can further analyze local data to identify mitigatable items which contribute to a risk of a natural hazard as described herein. In some embodiments, local data can be transmitted from the mobile computing device to an insurance management system so that analysis of the local data can be performed by a server computer of the insurance management system.

While FIG. 3A illustrates an embodiment where an application program for a mobile platform is downloaded to a mobile computing device, a browser-based website can be used on a mobile computing device to collect local data or to perform a risk analysis in other embodiments of the present invention.

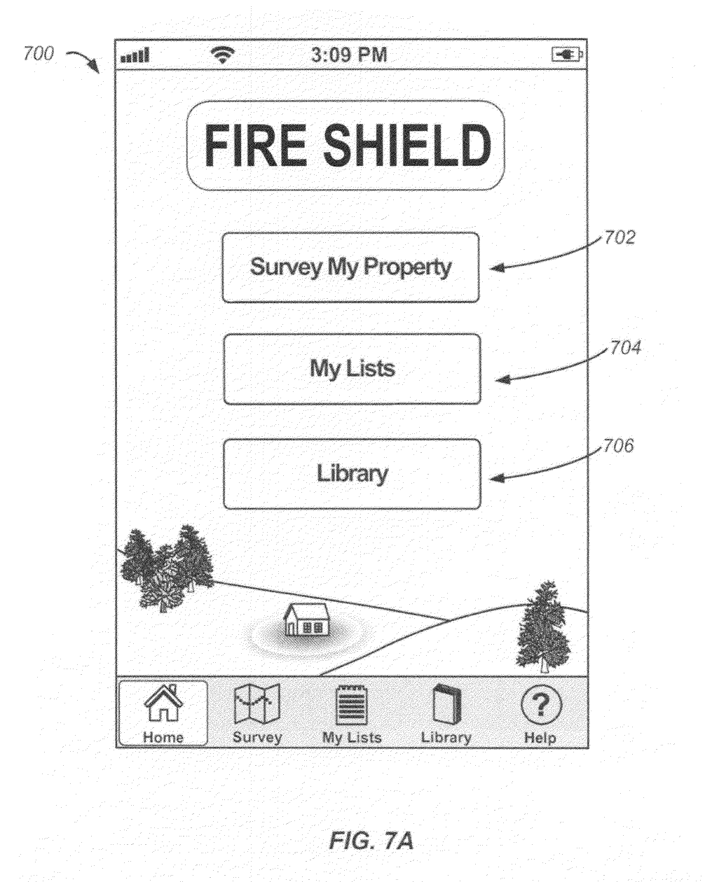

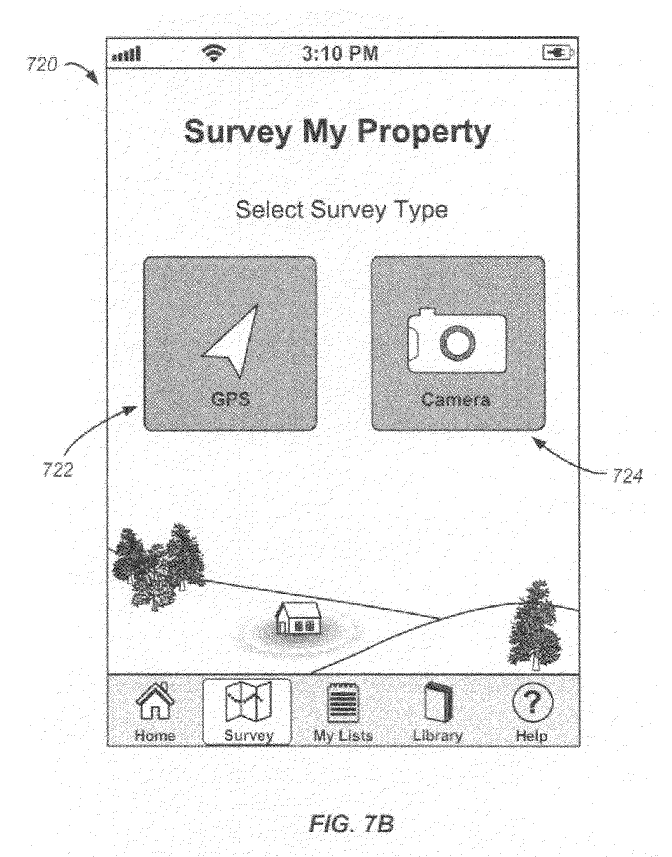

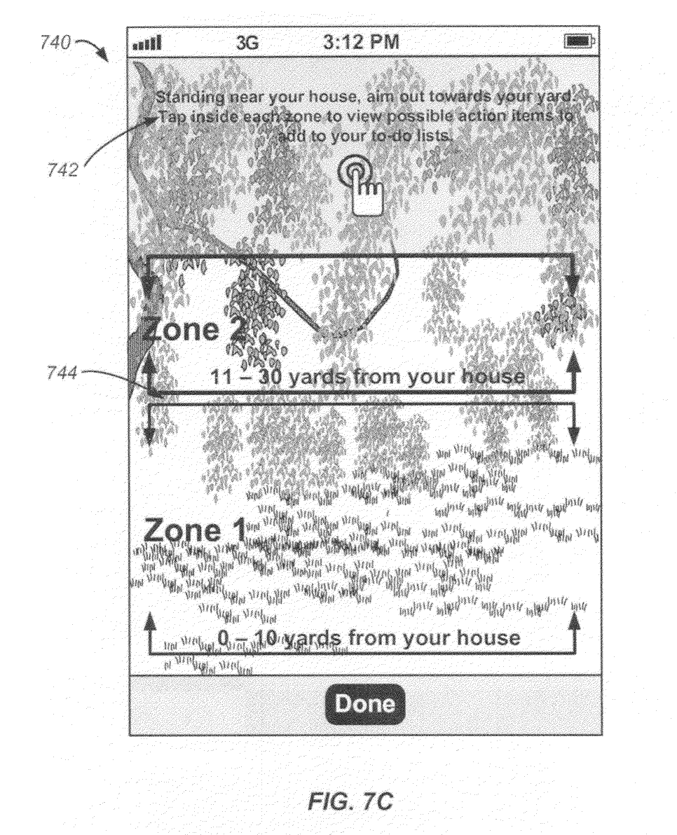

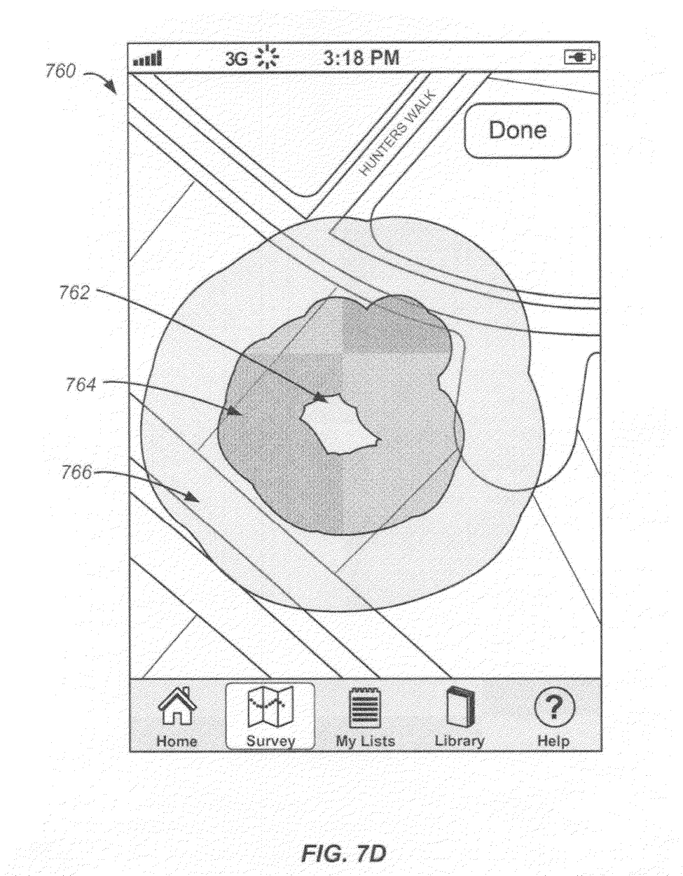

Referring to FIG. 3A, the method 300 also includes receiving a user request, through a mobile application, to survey the user's property by collecting local data within a predetermined vicinity of the user's property (306). In an embodiment of the present invention, a user request may include, for example, a selection of an icon for “Survey My Property” (shown in FIG. 7A) or a selection of a sensor for surveying the property (shown in FIG. 7B) displayed on a graphical user interface of the mobile computing device through the mobile application.

Upon receiving the user request to survey the property, the method 300 includes collecting local data using at least one sensor operatively coupled to a mobile computing device and/or deployed around the property (308). As used herein, local data refers to sensor data obtained from the vicinity of the user's property as opposed to data obtained from a broader area, such as a city, a county, a state, or the like. The vicinity of the user's property generally refers to a defensible space zone of the property. A defensible space zone is an area within a perimeter of a home where basic wildfire (or other natural hazard) protection practices are implemented, thereby providing key points of defense from an approaching wildfire. Generally, a defensible space zone is an area within about 30 feet of a home at a minimum, typically within about 100 feet of a home (or a building or a structure). As used herein, a vicinity of a piece of real property can also refer to an area surrounding a building and can also include the exterior portion or features of the building. The local data collected using one or more sensors can provide information related to risk factors, including mitigatable items associated with the property.

Augmented Images Using Camera

According to an embodiment of the present invention, enhanced reality or augmented reality can be provided by a mobile computing device through a mobile application to guide a homeowner in identifying risk factors around the user's property in real-time. The mobile application can overlay augmenting data, such as sound, text, graphics, or GPS data, on top of real-world images to be captured by a camera on the mobile computing device, thereby creating an augmented view of the real world. For example, real images shown on a screen of the camera may be overlaid with range-finder type lines showing a distance in yards or feet. The augmented images provided by embodiments of the present invention can assist a user in determining a perimeter of a defensible space zone within which any flammable items or other hazardous conditions should be cleared.

As an illustration, when a user stands by the user's house and holds up a mobile computing device with a camera lens facing towards an area of interest in the user's backyard, a real view of the area on the screen can be overlaid with range-finder type lines showing distance markers (e.g., yards or feet). The augmented view of the area can include important points, such as a distance from a building or a boundary around the building, within which items that act as fire fuel should be cleared. In embodiments of the present invention, typically, the distance markers displayed on the screen show a boundary of a defensible space zone in the backyard (e.g., 10 feet, 30 feet, or 100 feet from the house). The user can use these distance markers (instead of manually measuring the distance) as a guide to remove or modify potentially hazardous items within the boundary. In other embodiments, the mobile computing device can capture real-view or enhanced images of the exterior of the house to identify hazardous items, such as vent openings or cracked roof tiles which may allow entry of embers.

In another embodiment, augmented images can be collected through an application of a mobile computing device to identify latent dangers around real property related to other natural hazards such as floods. Even if the property is not located within a flood zone, the property may be subject to flooding, particularly during a torrential rain or a wind-driven rain. Conditions that promote flooding can include negative grading of a yard surrounding a house, a slope of the roof, a location of exterior doors, and the like. A homeowner's insurance policy generally does not cover floods such as water coming off the roof and splashing back up into the house or coming down from an incline into the house. Any latent dangers around the house can be identified from augmented images of the property using technologies according embodiments of the present invention. For example, an augmented image of a house showing a slope of the roof line above an exterior door, window, or other structure openings may indicate that flooding may occur around these structural features during a torrential rain.

In some embodiments, the flood risk can be assessed using an algorithm and augmented images of the property by simulating ways that a building can be flooded based on the design of the building, and the environment surrounding the building. As an example, high winds, rain fall levels (heavy, light, or the like), directional rain, wind-driven rain, or the like can be simulated using augmented images of the property. A homeowner may be informed of latent danger identified during simulation so that the homeowner can make changes to the home structure and/or the surrounding environment. After modifying the structure and/or surrounding environment, the flood risk simulations can be rerun to determine if the risk has been mitigated. The application can then provide a cost assessment to mitigate the flood risk. In some embodiments, after simulations, a homeowner may be advised to obtain a special line of insurance products, such as a flood insurance policy.

Slope Detector

In another embodiment the present invention, a mobile computing device can further include a laser slope detector as a sensor, which may be used to determine a distance and a slope to a target object in the backyard. The elevation of a terrain surrounding the property can affect the risk of a natural hazard associated with the property. For example, a wildfire typically travels faster uphill than downhill. Therefore, the property located on top of a hill with vegetation is more susceptible to a wildfire than the property located at downhill. Also, the grade or steepness of the hill surrounding the property can also influence the speed and burn path of a wildfire. The elevation and slope data captured by a mobile computing device can be used in determining a risk of a natural hazard associated with the property.

GPS Receiver

In another embodiment of the present invention, a GPS receiver in a mobile computing device can be used as a sensor to identify a boundary of a defensible space zone for a house or to identify locations of mitigatable items within the boundary. The GPS coordinates of a defensible space zone boundary and locations of mitigatable items, such as dry bushes or trees, may be physically marked on the ground with stakes and/or saved in the memory of the mobile computing device. In some embodiments, the GPS coordinates of mitigatable items may be communicated to an insurance company for record keeping purposes. In other embodiments, the GPS coordinates of mitigatable items may be communicated to a contractor who can selectively remove these items according to GPS coordinates without disturbing nonflammable, healthy trees or bushes.

Other Sensors

A mobile computing device can further receive local data from other sensors coupled to the mobile computing device or deployed around the property. As an example, a mobile computing device can include an odor sensor, such as Cyranose™, to detect odor of flammable or combustible items (e.g., paint, gasoline, propane gas leak, natural gas leak, any hidden items, or the like) around the property. As described in relation to FIG. 2, other sensors that can be deployed around the property include: soil sample sensors, thermometers, humidity sensors, wind sensors, cameras located on the property, thermal sensors, infrared and radiation sensors, lidar, animal activity and migration sensors, mobile biological sensors, vegetation and fuel loads monitors, DNA analyzer, and the like. These sensors can continuously or periodically collect local data related to the environment surrounding the property. The local data including sensor measurements can be transmitted to a mobile computing device, an insurance management system, or other systems in a server for further analysis.

Collection of Information from External Data

In embodiments of the present invention, additional external data can be combined with data obtained by the user's camera and other sensors (e.g., a GPS receiver). For example, external data, such as elevation and other topographical map information surrounding the property, can be used to assess a wildfire risk based on the location of the property. In another example, GIS data, such as topographical mapping, can be used together with other sensor data captured by the user to provide a view of the immediate and surrounding areas of the user's property based on elevation. Such data can be augmented with information about the possible burn path of a fire, wind speed and direction common to the area, or the like. The augmented data can be used to simulate a fire path surrounding the user's property based on its location. Such data can be used to educate the user about the area surrounding the property and different protection zones that can be created based on the global data. In addition, the data can be used by the mobile application on the mobile computing device or by one or more engines of the insurance management system to determine a wildfire risk associated with a particular location. Additionally or alternatively, the data can be reviewed by professional inspectors or wildfire fighters associated with the insurance company to receive their feedback.

Collection of Information from Internal Proprietary Data

In yet another embodiment, internal proprietary data related to the member and the home can be obtained from a company operating the insurance management system (e.g., an insurance company). For example, a homeowner's insurance policy can include property characteristics including basic construction information related to the property and brush zones (e.g., low, medium, or heavy) surrounding the property. When a member logs on and is authenticated by the system, the member's records can be retrieved from the internal database of the insurance management system. Other types of information that can be retrieved from the internal database can include the member's address, property information, name, assessed risk score rating, previous claims related to insurance, claims made by homeowners in the neighborhood, or the like.

Identification of Mitigatable Items

Referring to FIG. 3A, the method 300 further includes identifying, by the data processor, one or more mitigatable items that contribute to a risk of a natural hazard based on the local data (310). Mitigatable items can be objects or tasks that can be modified or removed by a person at a reasonable cost and man power, as part of a routine maintenance or an upgrade of a home. Examples of mitigatable items include flammable dry bushes and trees which can be cut or dry leaves in the gutter which can be removed. Another example of mitigatable items is roof opening vents (through which embers can enter) that can be shielded with a screen. The mitigatable items can be modified or removed at a reasonable cost by the owner of the property to reduce the wildfire risk. By contrast, if the property is located within a forest of dense vegetation, the forest is not considered as a mitigatable item since it cannot be removed at a reasonable cost.

Mitigatable items in the vicinity of the property can be identified in a number of different ways. As an example, they may be visually identified by a user when the user surveys the user's property with a mobile computing device as described in the present application. The user may mark the position of mitigatable items, such as a dry bush, with a stake on the ground. Alternatively, the user may mark the position of the dry bush with its GPS coordinates in the mobile computing device so that its position can be stored in its memory and communicated to third parties, such as an insurance company or a tree removal service company.

In some embodiments, if the user has questions regarding whether certain items are risk factors, the user can transmit an image or sensor measurements of the object to an insurance management system. The hazard mitigation procedures engine 130 of the insurance management system 110, shown in FIG. 1, can analyze the transmitted image to determine whether the items in the image should be removed or modified. Alternatively, the user can provide a real-time video feed or images over an area of concern, through a mobile computing device, and interact with professionals. For example, the user can consult with experts, such as professional wildfire fighters, associated with the insurance company or experts in plant species identification to receive their feedback in real-time.

In other embodiments, the object recognition software stored in a memory of a mobile computing device may be used to identify whether certain objects located around the user's property are risk factors. As an example, the object recognition software can distinguish different types of plants, including those with volatile foliage (e.g., Black Spruce) from fire resistant hardwood (e.g., Balsam Popular Aspen, Paper Birch, or the like) using images captured by a mobile computing device. According to an embodiment of the present invention, the data processor of a mobile computing device can automatically determine and identify volatile trees or other flammable items around the property as mitigatable items based on oil content in the identified trees, bark type, shape, or the like.

In some embodiments, plant identification software may be used to identify species of plants. Some plant species put on different heat signatures. Different heat signatures of plants and other objects can be detected by an infrared imaging sensor (e.g., infrared scan). In other embodiments, the plant materials can be identified through material analysis using a chemosensor, a DNA analyzer, or the like. Their identities and locations can be stored in the memory of the mobile computing device, databases of an insurance management system, a cloud or account based storage, or the like. In some embodiments, flammability of plants may be identified according to their color or size. For example, plants with dry, brown leaves are more flammable than well-hydrated, green-colored plants. Thus, flammability of plants can depend on the irrigation status of plants or recent rainfall for the region. In another example, sensors described in the present application can automatically identify mitigatable items based on sense signatures emitted by the mitigatable items, such as their odor, shape, taste, or the like.

In addition, external data described in the present application can be analyzed together with local data captured by one or more sensors to identify one or more mitigatable items in the vicinity of the property. The external data may include macro data such as data layers from GIS, environmental conditions such as drought conditions, lightning conditions, storm surge risk data, brush fire risk data, satellite data, or the like.

Educational Material and Inspection Checklist (FIGS. 3B and 3C)

In embodiments of the present invention, educational material, such as a hazard assessment checklist, may be provided to a user on a website operated by an insurance company. Alternatively, educational material may be downloaded to a mobile computing device as part of a mobile application in accordance with embodiments of the present invention. In some embodiments, the checklist may be incorporated into object recognition software so that mitigatable items in the checklist may be automatically identified from images from the property. The educational material may further include case studies of homeowners who mitigated risk factors versus those who did not, the images showing the impact of the mitigation versus the impact of non-mitigation after a wildfire, current news, fires in the area, or the like. Thus, embodiments of the present invention provide a holistic approach to educating, identifying, and mitigating risk factors of natural hazards associated with real property.

An example of a wildfire hazard assessment checklist is shown in FIGS. 3B and 3C. The checklist may be used to determine susceptibility of real property to wildfire flames and embers. Many items in the checklist can be easily mitigated to significantly reduce a wildfire risk. The items described in the checklist shown in FIG. 3B include mitigatable items related to a house or structure itself. The items in the checklist shown in FIG. 3C include mitigatable items related to combustible materials in a defensible space zone around the house. The checklist shown in FIGS. 3B and 3C is merely exemplary, and other checklists can be used to mitigate the risk of natural hazards. For example, separate checklists may be provided to mitigate the risk of floods, hailstorms, mudslides, or the like.

In some embodiments, an image of augmented reality can be used for educational purposes to illustrate to a user what mitigation should look like for the user's property. For example, if a mobile computing device scans an open vent on a building without any protection, a vent door or a screen that can shield the vent can be drawn in the scanned image. Such an augmented image provides a user with a visual illustration of mitigation for a vent opening.

Additionally, the user may be provided with a link for a website that sells the vent door or screen that can be used to shield the vent opening. Since the user's property information, including the vent size or shape, can be accessed from augmented images or external databases (e.g., a customer database of the insurance management system), suitable products can be recommended to the user. In an embodiment, if the user selects a specific brand of a product that is in a member shop on the website, the user who is a member of an insurance company may be offered a discounted price for the product. Thus, embodiments of the present invention can provide an integrative solution for a user in mitigating the risk of a natural hazard associated with the user's property.

Displaying Information and Recommendations for Mitigating Risk

Referring to FIG. 3A, after identifying mitigatable items that contribute to a risk of a natural hazard associated with the property, the method includes displaying information related to identified mitigatable items on a graphical user interface (312). The displayed information can also include mitigation procedures for modifying or removing the identified mitigatable items. For example, mitigation procedures can include contact information for contractors who are licensed to address the identified items. The displayed information can further provide a link to a website which sells products to mitigate the identified items (e.g., a screen to shield an open vent, a gutter cleaning tool, or the like).

Embodiments of the present invention may also provide a link to a social media networking site through which a user can share information related to a risk of a natural hazard associated with a particular property, neighborhood, city, or the like. A social media networking site may be operated by an insurance company or another entity, such as Facebook™ or Twitter™. It can also be a website operated by government, such as Firewise™. A social media networking site can also be used by members to invite others to place a bid on a project (e.g., trimming bushes). In another embodiment, an insurance company can provide a website through which members can share information, advice, and recommendations for mitigating the wildfire risk. The website can also provide information related to programs available in town, such as a free tree trimming service, for the community. Thus, embodiments of the present invention provide integrative solutions to problems rather than merely providing advice to users.

In embodiments of the present invention, the mitigatable items, mitigation procedures, and other associated information may be stored in any suitable database. For example, the mitigatable items may be stored in a database or memory of a mobile computing device or transmitted to an insurance management system and stored in its databases or in a server. In another example, the mitigatable items and associated information may be transmitted externally and stored on an external network, server, or device, such as a cloud based storage or an account based storage.

Reminders and Alerts

Mitigating against natural hazards is an ongoing process which should be performed periodically or continually. As an example, dry bushes surrounding the home must be cut or control-burned periodically to safeguard a home against a wildfire. In an embodiment of the invention, a reminder for mitigation can be communicated to a user through one or more communication channels, including a mobile application, a web browser accessible through the Internet, short message service (SMS) text message, multimedia message service (MMS) message, electronic mail (e-mail), telephone call, Voice over IP (VoIP) communication, and the like. A reminder can be provided periodically (e.g., monthly, quarterly, or the like) to reassess risk factors around the property.

In some embodiments, an alert can be transmitted during a particular hazard season. As an example, an alert can be transmitted to a homeowner during a wildfire season. The alert may further include information related to current locations of wildfires in a greater area (e.g., neighborhood, zip code, city, or county in which the property is located). The alert may further include mitigation procedures and recommendations. As an example, an alert may include an inquiry as to whether a homeowner has dealt with previously identified mitigatable items (e.g., an open vent). The alert may further provide an immediate solution to the problem (e.g., suggesting a link for a website or store that sells a product to shield the open vent).

While FIG. 3A illustrates the use of a mobile application and a mobile computing device for determining mitigatable items from local data and/or external data, the data may be transmitted to an insurance management system for analysis. After determining mitigatable items from the data by the engines in the insurance management system or via cloud computing using a remote server, this information may be provided to a user via a mobile application or on a personal web page that the user can access via a web browser.

It should be appreciated that the specific steps illustrated in FIG. 3A provide a particular method of processing local data to determine mitigatable items of a natural hazard associated with real property according to an embodiment of the present invention. Other sequences of steps may also be performed according to alternative embodiments. For example, alternative embodiments of the present invention may perform the steps outlined above in a different order. Moreover, the individual steps illustrated in FIG. 3A may include multiple sub-steps that may be performed in various sequences as appropriate to the individual step. Furthermore, additional steps may be added or removed depending on the particular applications. One of ordinary skill in the art would recognize many variations, modifications, and alternatives.

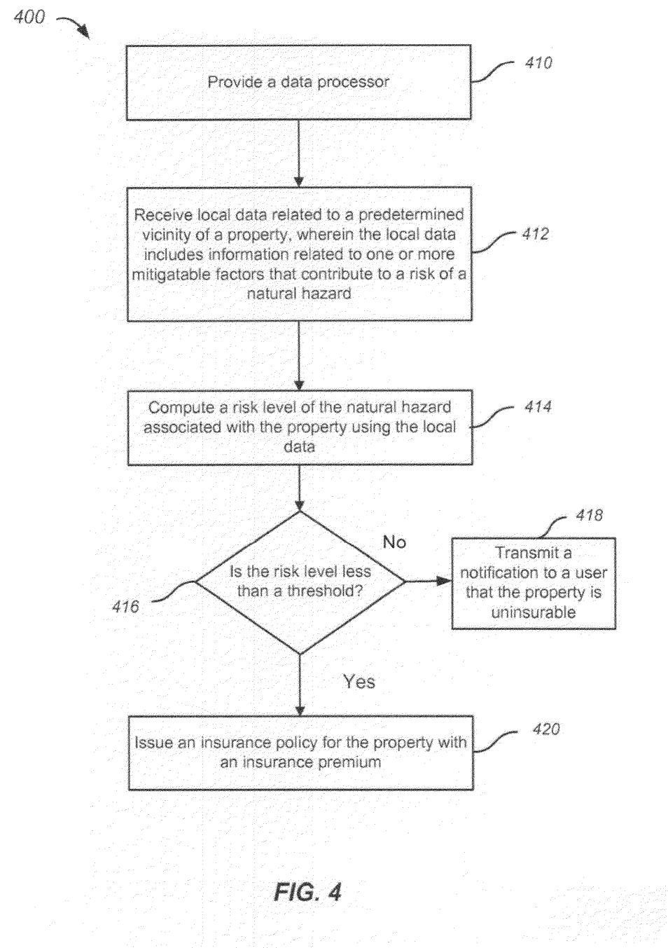

FIG. 4—Risk Assessment and Insurance Policy Issuance

FIG. 4 is a high level flowchart illustrating a method of issuing an insurance policy for real property according to an embodiment of the present invention. The method 400 includes providing a data processor (410). The data processor may be a processor in a mobile computing device or a server computer in an insurance management system illustrated in FIGS. 1 and 2. The method includes receiving local data related to a predetermined vicinity of real property, wherein the local data is collected from one or more sensors described in the present application (412). For example, a sensor may include a camera, a GPS receiver, an odor sensor, a wind sensor, a temperature sensor, a humidity sensor, or the like. In an embodiment of the present invention, one or more sensors may be incorporated in the mobile computing device. In other embodiments, one or more sensors deployed around the property can be used to collect local data.

As shown in FIG. 4, the method further includes computing, by a data processor, a risk level of a natural hazard associated with the property based on the collected local data (414). In one embodiment, the local data collected by one or more sensors described in the present application can be used to calculate a risk level of a natural hazard associated with real property. In another embodiment, additional information related to the property and its surrounding neighborhood can be used in the computation. The additional information can be obtained from third party data providers, public databases, or government databases. As an example, by entering a property address on a website operated by a third party data provider, the property building details and materials (e.g., stone versus wooden exterior, roof material, or the like) can be obtained.

In yet another embodiment, internal proprietary data related to the member and home can be obtained from a company operating the insurance management system 110. An insurance company holds proprietary information about members and their homes. For example, a homeowner's insurance policy can include property characteristics including basic construction information related to the property and brush zones (e.g., low, medium, or heavy) surrounding the property. When a member logs on and is authenticated by the system, the member's records can be retrieved from the internal database of the insurance management system.

Additional information about the property can be also obtained from others based on social media or other suitable techniques. A person living in or passing by a location can provide data inputs used by the system described herein. For example, photos or other information related to a piece of real property or location can be obtained through social media sites, and such data can be prioritized to improve the quality of information related to the property or location. The additional information can be used together with the local data collected from one or more sensors to accurately assess a risk of a natural hazard associated with the property.

In embodiments of the present invention, any gap in information related to the property can be presented to a homeowner, for example, through an augmented reality using a mobile application. Feedback can be obtained from the homeowner in real-time to satisfy the gap of information. For example, if the insurance management system cannot determine whether the exterior of a house is made of limestone, an augmented image of the exterior of the house can be displayed on a graphical user interface of the homeowner's mobile computing device. The augmented image may be presented with a question with answer choices from which a homeowner can select. The homeowner can provide feedback to the insurance system by clicking an answer choice on the graphical user interface. In another example, if an image of a house (e.g., an aerial image) appears to indicate that the roof has been replaced with an asphalt shingle roof (as opposed to a wooden roof as indicated in the current insurance policy records), then the image of the roof can be displayed for the user with a request for verification. When the user verifies that the roof has been replaced with a fire resistant roof (e.g., asphalt shingle), the insurance management system can update the user's information in a database and perform an updated risk computation to adjust an insurance premium for the user.

In another embodiment, additional information related to a piece of real property or the surrounding neighborhood can be aggregated from various users through a mobile application of their mobile computing device. As an example, a user passing by a neighborhood can provide augmented images of the neighborhood using the mobile application in accordance with embodiments of the present invention. The user may be a street car driver (e.g., Google Street View™ drivers) hired by a company or any consumers who may be interested in collecting and selling data to interested parties. Google Street View Maps™ or other user gathered maps can be augmented with augmenting data (e.g., distance markers, slope markers, marking dangerous or flammable objects, or the like) by using a mobile application in accordance with embodiments of the present invention. The augmented images can be provided through an input portal provided by an insurance company. The users can provide the augmented images to the insurance company for a fee or free of charge. The user-generated information can improve the quality of information related to a particular piece of property or its surrounding neighborhood.

In other embodiments, data layers from geographical information system (GIS) may be utilized, in combination with local data obtained from sensors, to calculate a risk of a natural hazard associated with the property. A GIS is a data system designed to capture, analyze, and present all types of geographically referenced data. The GIS can be used to combine layers of information related a selected geographic location to provide a better understanding of the location. For example, GIS data may include storm surge risk data, brush fire risk data, population concentration data, data related to different business measurements, precipitation data, satellite images, local weather, or the like. In an embodiment, the GIS data can be fed into a mobile application and can be combined with local data related to a specific piece of property captured by sensor measurements. As an example, the GIS data may indicate that the area in which the property is located is under drought. However, the local data captured by one or more sensor may indicate that the property is irrigated and has fire resistant vegetation surrounding the property. In embodiments of the present invention, the GIS data may be presented on a map. The GIS data may be overlaid over a local map generated by a user's mobile computing device. By overlaying GIS data layers over local data, any gap in information related to the property or its surrounding can be filled.

In some embodiments, different jazz technology data layers can be used to assess a risk of a natural hazard at a macro level. The macro level data layers may include information related to areas far beyond a defensible space zone of a home, for example, beyond 100 feet, a half of a mile, a zip code level, or the like. For example, a macro level data layer may provide information related to a certain type of vegetation that predominates in, for example, Southern Texas or Northern Texas where the property is located at. In another example, a macro level data layer may indicate that a high density of combustible vegetation spans continuously for many miles around the property. The macro level information for a broader area surrounding the property can be combined with local data to build a virtual house and a mosaic of information to better assess the overall risk of a natural hazard associated with the property as well as a greater area surrounding the property.

All of the local data and other data layers can be stored in a database of an insurance management system, in the memory of the computing device, or in an external network or a server. Using the available data, a proprietary data layer that measures risks at the macro level and specific property level can be created by an organization operating the insurance management system. The proprietary data layer can be commercialized by the organization by allowing interested parties (e.g., other insurance companies, realtors, builders, government, homeowner's association, or the like) to access the proprietary data layer for a fee. In an embodiment, the proprietary data layer can be provided with a certification by the organization so that purchasers of the proprietary data layer can be assured of the quality and accuracy of the data layer.

In embodiments of the present invention, any suitable computing algorithm may be used to compute a risk level of a natural hazard associated with a piece of real property. In some embodiments, an algorithm may be developed to correlate types of properties more susceptible to wildfires by analyzing conditions that fueled wildfires during previous disasters. Data analyzed in developing an algorithm may include a density of neighboring properties surrounding the property, a density or type of vegetation surrounding the property, burning characteristics of different plants, amount of asphalt between properties, direction of prevailing wind, geographical features such as presence of a body of water (e.g., river), or the like. Such data can provide information related to conditions that promote ignition or spread of a wildfire.

As an illustration, characteristics of Santa Ana winds in Southern California and the pattern of damage caused by the wind are analyzed to develop an algorithm to predict a risk level for real property in or around the path of Santa Ana winds. Such an algorithm may be used to identify specific pieces of real property that are more susceptible to wildfires. In addition, an algorithm may also be used to simulate a scenario of how a wildfire will approach and damage the property. The simulation may also include how removing risk factors would affect the wildfire risk. The algorithm can also be used to develop an effective evacuation plan as it can forecast how a wildfire will behave in certain areas.

In an algorithm, presence of any mitigatable items in the checklist discussed in, for example, FIGS. 3B and 3C may be added as risk factors. Additionally, presence or absence of features described in “Adjacent Surroundings/Environment” and “Fire Protection Concerns Not Related to the Potential Ignition of the Homes” in the checklist can be considered in the computation as risk factors. Some of these features in the checklist are not typically mitigatable by a homeowner.

A risk level of a natural hazard associated with real property can be computed using any suitable method. As an example, a risk level can be computed and quantitatively indexed on a scale of 1 to 100 (or any other suitable ranking), semi-quantitative (e.g., high, medium, or low), or the like. As an illustration, the presence of mitigatable items on real property and the presence of non-mitigatable conditions shown in the above checklists may be assigned various points. After the property is surveyed using methods and systems described herein, points corresponding to each item or condition may be added if they are present. The points can be scaled to provide an indexed risk level of a wildfire associated with the property. In embodiments of the present invention, the computed risk level is then provided to the user on a graphical user interface or communicated to the user using any suitable communication modes.

After computing a risk level of the property, the risk level is compared to a threshold (416). If the risk level of a natural hazard associated with the property is greater than the threshold, then a notification is transmitted to a user that the property is uninsurable (418). If the risk level of a natural hazard is less than the threshold, then a user may be notified via any suitable communication channels. The notification may include an offer or an issuance of an insurance policy with an insurance premium which is correlated with the risk level of the property (420). In embodiments of the present invention, an insurance policy may be a homeowner's insurance policy or a special line of insurance policies, such as a wildfire insurance policy, a flood insurance policy, or the like.

In some embodiments, the analysis of the risk level of a natural hazard is performed upon request, whereas in other embodiments, it is performed on a real-time basis, running behind the scenes. When a user is a potential buyer, a realtor, or an investor who is interested in real property, the user may input an address of the property into a website operated by an insurance company, and the results including insurability and an insurance premium may be presented to the user.

It should be appreciated that the specific steps illustrated in FIG. 4 provide a particular method of issuing an insurance policy for real property according to an embodiment of the present invention. Other sequences of steps may also be performed according to alternative embodiments. For example, alternative embodiments of the present invention may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. One of ordinary skill in the art would recognize many variations, modifications, and alternatives.

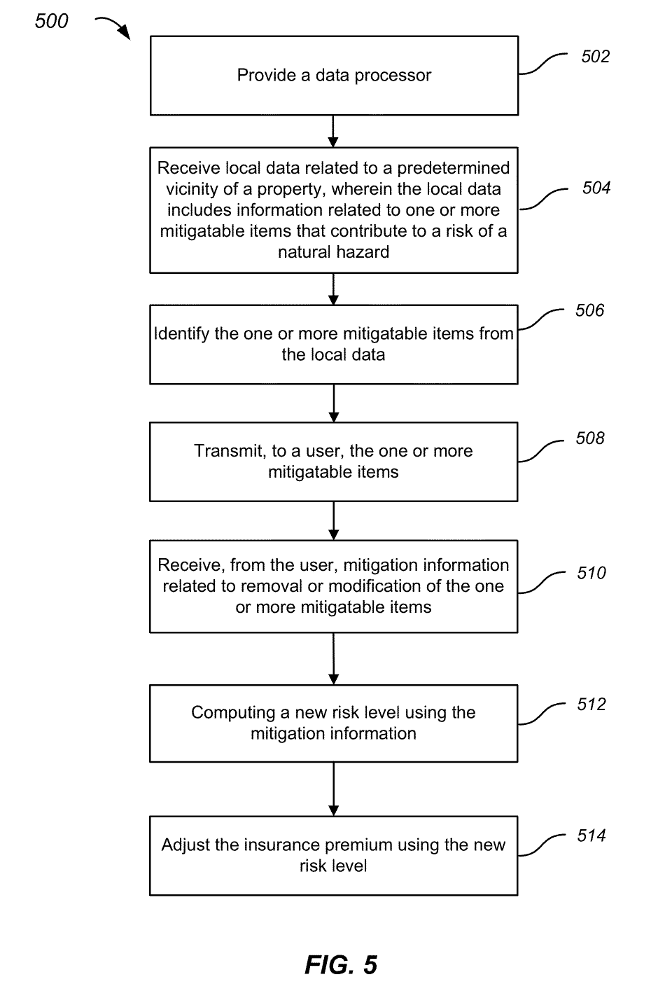

FIG. 5—Adjustment of Insurance Premium

FIG. 5 is a high level flowchart illustrating a method of adjusting an insurance premium for a piece of real property according to an embodiment of the present invention. In evaluating a new application for property insurance, systems and methods in accordance with the present invention can be used to determine a risk level of a natural hazard associated with the property. If the risk level is above an acceptable range according to an underwriting algorithm, then an application for a new policy may be declined. If it is determined that the risk level can be reduced through removal or modification of mitigatable items or hazardous conditions, then a new policy may be issued with a condition that mitigatable items will be addressed within a predetermined period of time. Similarly, the property insurance renewal can be conditional on the homeowner mitigating hazardous conditions identified by systems and methods in accordance with the present invention. Thus, a homeowner can take a proactive role in reducing a risk level of a natural hazard associated with the property and an insurance premium. An insurance premium for an insurance policy can be lowered for the property according to the reduced risk level, which, in turn, will provide an incentive for a homeowner to continuously mitigate potential risk factors surrounding the property.

As shown in FIG. 5, the method 500 includes providing a data processor (502). The data processor may be a processor in a mobile computing device or in a server computer in an insurance management system illustrated in FIGS. 1 and 2. The method includes receiving local data, collected from one or more sensors, related to a predetermined vicinity of the property (504). The received local data comprises information related to mitigatable items associated with the property and its vicinity. The method 500 further includes identifying the mitigatable items from the local data (506). As discussed in relation to FIG. 3A, the mitigatable items may be identified by the user visually or by technologies described in the present application. The information related to the mitigatable items are displayed on a graphical user interface or transmitted to the user via any suitable communication channels (508). Additionally, external data may be analyzed in conjunction with the local data to identify mitigatable items and for risk assessment.

Upon receiving information related to mitigatable items, the user can remove or modify mitigatable items to reduce a risk of a natural hazard associated with the user's property. As an example, if the user receives information that combustible bushes exist within a 30 feet zone of the house or that an open roof vent increases a risk of ember entry into the home, then the user can choose to remove the combustible bushes and to shield the open roof vent. After mitigating items identified by the system, the user may transmit mitigation information—evidence of mitigation efforts to an insurance company in the form of a photo, a video, other images, or the like (510). After receiving mitigation information from the user, a data processor and a hazard computation engine 135 can re-calculate a new risk level using the mitigation information submitted by the user (512). Based on the new risk level, an insurance premium calculated based on pre-mitigation information may be adjusted using the new risk level of a natural hazard associated with the property (514), other external data (e.g., GIS data layers), or the like. Thus, by being proactive and mitigating hazardous conditions, a homeowner can be an active participant in determining insurability and an insurance premium associated with the property.

Embodiments of the present invention can also be applied to other types of insurance policies or government taxes. Safety of an individual property is dependent upon safety of the overall neighborhood. Mitigation efforts of an organization in a neighborhood, such as a homeowner's association, may be taken into consideration in computing an insurance premium. For example, the overall risk of the neighborhood can be assessed from aerial images. When it is determined that the overall risk of a neighborhood has been decreased because of a homeowner's association's mitigation efforts (e.g., trimming dry trees around the neighborhood), an insurance premium may be reduced for homeowner's association insurance as well as for individual policies for houses within the neighborhood. Therefore, mitigation efforts can be rewarded at the organization level as well as at the individual level.

To encourage mitigation efforts for all members at the organization level, a centralized web page can be created for an organization (e.g., a homeowner's association) so that mitigation efforts by individual households can be displayed on the website. Such a centralized website would create a peer pressure and incentives for all members of the homeowner's association to reduce or remove any mitigatable items around their individual homes and the neighborhood. In some embodiments, users who reduce the risk of natural hazards may be rewarded in the form of a property tax break from the government.

Mitigating a risk of a natural hazard is an ongoing process, and conditions around the property are reassessed continuously or periodically (e.g., daily, weekly, monthly, quarterly, or the like). Since the risk of a natural hazard can be assessed in real-time through telematics technology described in the present application, insurance premiums can be adjusted, in real-time, continuously or periodically according to an updated risk level. The risk level may be also updated after mitigation. In some embodiments, a variable premium which fluctuates over time may be provided depending on updated conditions surrounding the property.

It should be appreciated that the specific steps illustrated in FIG. 5 provide a particular method of adjusting an insurance premium according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

FIGS. 7A-7D—Surveying Real Property Using a Mobile Application

FIGS. 7A through 7D are high level schematic diagrams illustrating a graphical user interface displayed on a mobile computing device. Fire Shield shown on page 700 in FIG. 7A can be used to survey real property to determine mitigatable items on or around the property according to an embodiment of the present invention. The graphical user interface displays several icons that the user can select: “Survey My Property” 702, “My Lists” 704, and “Library” 706. The “Survey My Property” icon 702 can be selected to identify mitigatable items on or around the property using sensors described in the present application. The “My Lists” icon 704 can be selected to view a stored list of mitigatable items detected by the sensors. The “Library” icon 706 can be selected to review a wildfire hazard assessment checklist or other information related to wildfires.

When the “Survey My Property” icon 702 is selected by a user, a page 720 shown on FIG. 7B is displayed on a graphical user interface of the mobile computing device. In an embodiment illustrated in FIG. 7B, two types of survey icons are displayed: a “GPS” icon 722 and a “Camera” icon 724. The user can select either icon to survey the property to identify and mark locations of mitigatable items.

When the “Camera” icon 724 is selected by the user, a page 740 shown in FIG. 7C is displayed on a graphical user interface of the mobile computing device. As shown on page 740, an image of where the camera lens is pointing is displayed on the screen along with an instruction 742 for aiming the camera towards a user's yard. In an embodiment illustrated in FIG. 7C, the real view image is augmented with line markers 744 showing a distance of a target from the house. Zone 1 shows an area in the yard between 0 and 10 yards from the house, and Zone 2 shows an area in the yard between 11-30 yards from the house. The instruction 742 further directs a user to tap inside each zone to view possible action items (e.g., mitigatable items) and to add them to the user's to-do-lists.

FIG. 7D illustrates a page 760 that displays an aerial map of the property and its surrounding. The property 762 is shown as being surrounded by Zone 1 (764), which is surrounded by Zone 2 (766). Using the camera and/or other sensors described in the present application, mitigatable items can be identified and stored in a memory of the mobile computing device.

FIG. 6—Computer System

FIG. 6 is a high level block diagram illustrating a computer system including instructions to perform any one or more of the methodologies described herein. A system 600 includes a computer 610 connected to a network 230. The computer 610 includes a processor 620 (also referred to as a data processor), a storage device 622, an output device 624, an input device 626, and a network interface device 628, all connected via a bus 630. The processor 620 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 620 executes instructions and includes that portion of the computer 610 that controls the operation of the entire computer. Although not depicted in FIG. 6, the processor 620 typically includes a control unit that organizes data and program storage in memory and transfers data and other information between the various parts of the computer 610. The processor 620 receives input data from the input device 626 and the network 230 reads and stores code and data in the storage device 622 and presents data to the output device 624.

Although the computer 610 is shown to contain only a single processor 620 and a single bus 630, the disclosed embodiment applies equally to computers that may have multiple processors and to computers that may have multiple busses with some or all performing different functions in different ways.

The storage device 622 represents one or more mechanisms for storing data. For example, the storage device 622 may include read-only memory (ROM), random access memory (RAM), magnetic disk storage media, optical storage media, flash memory devices, and/or other machine-readable media. In other embodiments, any appropriate type of storage device may be used. Although only one storage device 622 is shown, multiple storage devices and multiple types of storage devices may be present. Further, although the computer 610 is drawn to contain the storage device 622, it may be distributed across other computers, for example on a server.

The storage device 622 includes a controller (not shown in FIG. 6) and data items 634. The controller includes instructions capable of being executed on the processor 620 to carry out the methods described more fully throughout the present specification. In another embodiment, some or all of the functions are carried out via hardware in lieu of a processor-based system. In one embodiment, the controller is a web browser, but in other embodiments the controller may be a database system, a file system, an electronic mail system, a media manager, an image manager, or may include any other functions capable of accessing data items. Of course, the storage device 622 may also contain additional software and data (not shown), which is not necessary to understand the invention.

Although the controller and the data items 634 are shown to be within the storage device 622 in the computer 610, some or all of them may be distributed across other systems, for example on a server and accessed via the network 230.

The output device 624 is that part of the computer 610 that displays output to the user. The output device 624 may be a liquid crystal display (LCD) well-known in the art of computer hardware. But, in other embodiments the output device 624 may be replaced with a gas or plasma-based flat-panel display or a traditional cathode-ray tube (CRT) display. In still other embodiments, any appropriate display device may be used. Although only one output device 624 is shown, in other embodiments any number of output devices of different types, or of the same type, may be present. In an embodiment, the output device 624 displays a user interface.

The input device 626 may be a keyboard, mouse or other pointing device, trackball, touchpad, touch screen, keypad, microphone, voice recognition device, or any other appropriate mechanism for the user to input data to the computer 610 and manipulate the user interface previously discussed. Although only one input device 626 is shown, in another embodiment any number and type of input devices may be present.

The network interface device 628 provides connectivity from the computer 610 to the network 230 through any suitable communications protocol. The network interface device 628 sends and receives data items from the network 230.

The bus 630 may represent one or more busses, e.g., USB (Universal Serial Bus), PCI, ISA (Industry Standard Architecture), X-Bus, EISA (Extended Industry Standard Architecture), or any other appropriate bus and/or bridge (also called a bus controller).

The computer 610 may be implemented using any suitable hardware and/or software, such as a personal computer or other electronic computing device. Portable computers, laptop or notebook computers, PDAs (Personal Digital Assistants), mobile phones, pocket computers, tablets, appliances, telephones, and mainframe computers are examples of other possible configurations of the computer 610. For example, other peripheral devices such as audio adapters or chip programming devices, such as EPROM (Erasable Programmable Read-Only Memory) programming devices may be used in addition to, or in place of, the hardware already depicted.

The network 230 may be any suitable network and may support any appropriate protocol suitable for communication to the computer 610. In an embodiment, the network 230 may support wireless communications. In another embodiment, the network 230 may support hard-wired communications, such as a telephone line or cable. In another embodiment, the network 230 may support the Ethernet IEEE (Institute of Electrical and Electronics Engineers) 802.3x specification. In another embodiment, the network 230 may be the Internet and may support IP (Internet Protocol). In another embodiment, the network 230 may be a local area network (LAN) or a wide area network (WAN). In another embodiment, the network 230 may be a hotspot service provider network. In another embodiment, the network 230 may be an intranet. In another embodiment, the network 230 may be a GPRS (General Packet Radio Service) network. In another embodiment, the network 230 may be any appropriate cellular data network or cell-based radio network technology. In another embodiment, the network 230 may be an IEEE 802.11 wireless network. In still another embodiment, the network 230 may be any suitable network or combination of networks. Although one network 230 is shown, in other embodiments any number of networks (of the same or different types) may be present.

A user computer 250 can interact with computer 610 through network 230. The user computer 250 includes a processor 252, a storage device 254, and an input/output device 256. The description related to processor 620 and storage device 622 is applicable to processor 252 and storage device 254. As an example, the user computer 250 can be a personal computer, laptop computer, or the like, operated by a member of a membership organization (e.g., the present assignee). Using the user computer 250, the member can then interact with computer 610 operated by the present assignee through network 230 in order to access the present assignee's web pages or the like.

The embodiments described herein may be implemented in an operating environment comprising software installed on any programmable device, in hardware, or in a combination of software and hardware. Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

It is also understood that the examples and embodiments described herein are for illustrative purposes only and that various modifications or changes in light thereof will be suggested to persons skilled in the art and are to be included within the spirit and purview of this application and scope of the appended claims.

1. A method performed by a data processor of a mobile computing device for providing mitigatable item information for real property, the method comprising:
providing the data processor, a memory, and at least one sensor, wherein the memory and the at least one sensor are operatively coupled to the data processor;
receiving a user request at the mobile computing device to collect local data within a predetermined vicinity of a piece of real property, the user request including the predetermined vicinity, the local data to be collected using the at least one sensor wherein the local data includes information related to mitigatable items that can be mitigated to reduce a wildfire risk associated with the property;
collecting the local data via the at least one sensor;
determining, via the data processor accessing the memory, one or more of the mitigatable items using the local data;
providing information related to the one or more of the mitigatable items to the user; and
storing the local data to the memory.

2. The method of claim 1 wherein the at least one sensor is a camera included in the mobile computing device.

3. The method of claim 2 wherein the local data includes an image of the predetermined vicinity of the property captured by the camera of the mobile computing device.

4. The method of claim 3 further comprising:
providing augmenting data that relates to the mitigatable items to reduce a wildfire risk associated with the property;
displaying the image of the predetermined vicinity of the property; and
overlaying the augmenting data on the image.

5. The method of claim 4 wherein the augmenting data comprises distance markers showing a distance between a location of the mobile computing device and locations of the one or more of the mitigatable items.

6. The method of claim 1 wherein the at least one sensor is a GPS receiver included in the mobile computing device.

7. The method of claim 2 wherein the at least one sensor comprises both the camera and a second sensor selected from the group consisting of an odor sensor, a humidity sensor, a temperature sensor, and a wind sensor, and wherein the second sensor is deployed in the vicinity of the property, the method further comprising collecting additional local data from the second sensor.

8. The method of claim 1 wherein the predetermined vicinity of the property comprises a 100 foot defensible space zone surrounding the property.

9. The method of claim 1 wherein the one or more of the mitigatable items includes flammable materials.

10. The method of claim 1 further comprising providing a mitigation procedure for removing or modifying the one or more of the mitigatable items.

11. The method of claim 1 wherein the local data includes an image of vegetation in the predetermine vicinity of the property captured by the at least one sensor, the method further comprising:
identifying, using the data processor, a species of the vegetation; and
determining whether the vegetation species enhances the wildfire risk associated with the property above a threshold.

12. The method of claim 1 further comprising:
generating a first map including the predetermined vicinity of the property;
identifying locations of the one or more of the mitigatable items on the first map; and
displaying the first map on a graphical user interface of the mobile computing device and marking the locations of the one or more of the mitigatable items on the first map.

13. The method of claim 12 further comprising:
displaying a second map showing a greater area surrounding the predetermined vicinity of the real property, wherein the second map includes macro data related to the greater area and the macro data includes information related to a greater area wildfire risk associated with the greater area;
overlaying the first map and the second map; and
determining, using the data processor, additional risk factors that contribute to the wildfire risk associated with the property.

14. The method of claim 1 wherein the method is performed through an application downloaded on the memory of the mobile computing device.

15. A non-transitory computer-readable storage medium comprising a plurality of computer-readable instructions tangibly embodied on the computer-readable storage medium, which, when executed by a data processor, provide mitigatable item information for real property, the plurality of instructions comprising:
instructions that cause the data processor to receive a user request to collect local data within a predetermined vicinity of a piece of real property using at least one sensor operatively coupled to a mobile computing device wherein the local data includes information related to mitigatable items that can be mitigated by a user to reduce a wildfire risk associated with the property;
instructions that cause the data processor to collect the local data using the at least one sensor;
instructions that cause the data processor to determine one or more of the mitigatable items using the at least one sensor; and
instructions that cause the data processor to display, on a graphical user interface of the mobile computing device, the one or more of the mitigatable items.

16. The non-transitory computer-readable storage medium of claim 15 wherein the plurality of instructions are configured to be downloaded as an application on the mobile computing device.

17. A method of providing an insurance policy for real property, the method comprising:
providing a data processor;
receiving local data related to a predetermined vicinity of a piece of real property, which is collected by at least one sensor, wherein the local data includes information related to mitigatable items that can be mitigated to reduce a wildfire risk associated with the real property;
computing, using the data processor, at least based on the local data, a risk level of the wildfire risk associated with the real property;
determining, using the data processor, whether the risk level is less than a threshold; and
issuing an insurance policy for the real property with an insurance premium, if the risk level is less than the threshold.

18. The method of claim 17 further comprising:
determining that the risk level is above a threshold; and
transmitting a notification to a user that the real property is uninsurable.

19. The method of claim 17 further comprising:
determining the one or more of the mitigatable items from the local data;
transmitting, to a user, information related to the one or more of the mitigatable items;
receiving, from the user, mitigation information related to removal or modification of the one or more of the mitigatable items to reduce the risk level;
computing, using the data processor, a new risk level using the mitigation information; and
adjusting the insurance premium using the new risk level.

20. The method of claim 17 wherein computing the risk level of the wildfire risk associated with the real property further includes analyzing a greater area wildfire risk associated with a greater area surrounding the predetermined vicinity of the real property.

21. The method of claim 4, wherein the augmenting data includes a distance that identifies a defensible space zone.

22. The method of claim 21, wherein the defensible space zone is a boundary around a building.

23. The method of claim 21, the method further comprising calculating, via the data processor, a burn path for a fire, wherein the distance is at least partly based on the calculated burn path.

24. The method of claim 1 further comprising identifying a GPS coordinate for at least one of the mitigatable items that can be mitigated to reduce a wildfire risk associated with the property.

25. The method of claim 1, wherein a first mitigatable item of the mitigatable items relates to a building.
